(19) United States
(12) Patent Application Publication
(10) Pub. No.: US 2026/0261528 A1
(43) Pub. Date: Sep. 3, 2026

(54) TRANSMISSION APPARATUS AND TRANSMISSION METHOD

(71) Applicant: Sony Semiconductor Solutions Corporation, Kanagawa (JP)

(72) Inventors: Kosuke Ozaki, Kanagawa (JP); Tetsuya Hiraoka, Kanagawa (JP)

(21) Appl. No.: 19/163,190

(22) PCT Filed: Apr. 2, 2024
(86) PCT No.: PCT/JP24/13542

§ 371 Date: Sep. 8, 2025

(30) Foreign Application Priority Data
Apr. 17, 2023 (JP) 2023-067213

(51) Int. Cl. H04L 49/55

(52) U.S. Cl. CPC H04L 49/555; H04L 49/557

(57) ABSTRACT

The present disclosure relates to a transmission apparatus and a transmission method each making it possible to achieve reproducible evaluation. The transmission apparatus includes a transmission unit that transmits and receives packets to and from another transmission apparatus coupled via an A-PHY I/F defined in a MIPI standard. The transmission unit includes a first insertion section that inserts an error in a specific position of a specific transmission packet, out of transmission packets to be transmitted to the other transmission apparatus, based on a first parameter preset. The present disclosure is applicable to the transmission apparatus in accordance with the MIPI standard, for example.

### TECHNICAL FIELD

The present disclosure relates to a transmission apparatus and a transmission method, and in particular to a transmission apparatus and a transmission method each making it possible to achieve reproducible evaluation.

### BACKGROUND ART

The automotive PHY (A-PHY) is one of the standards defined in the mobile industry processor interface (MIPI) alliance. The A-PHY is a standard for a PHY layer of SerDes (Serializer/Deserializer) for in-vehicle applications. A-PHY has a retransmitting function for a packet that has failed to be received due to external noises. In order to evaluate this retransmitting function, an error needs to be generated in the packet. Various functions for intentionally generating an error have been proposed. For example, Patent Literature 1 discloses an evaluation system of a wireless communication device that executes the evaluation of a Chase HARQ function.

### CITATION LIST

### Patent Literature

Patent Literature 1: Japanese Unexamined Patent Application Publication No. 2008-153729

### SUMMARY OF THE INVENTION

### Problems to be Solved by the Invention

In order to evaluate the retransmitting function of a packet in the A-PHY, an error needs to be generated in the packet, and a proposal for achieving reproducible evaluation has been required.

The present disclosure has been made in view of such circumstances, and an object thereof is to achieve reproducible evaluation.

### Means for Solving the Problem

A transmission apparatus according to one aspect of the present disclosure includes a transmission unit that transmits and receives packets to and from another transmission apparatus coupled via an A-PHY I/F defined in a MIPI standard. The transmission unit includes a first insertion section that inserts an error in a specific position of a specific transmission packet, out of transmission packets to be transmitted to the other transmission apparatus, based on a first parameter preset.

A transmission method according to one aspect of the present disclosure includes transmitting and receiving, with a transmission apparatus, packets to and from another transmission apparatus coupled via an A-PHY I/F defined in a MIPI standard, and inserting an error in a specific position of a specific transmission packet, out of transmission packets to be transmitted to the other transmission apparatus.

According to the transmission apparatus and the transmission method according to one aspect of the present disclosure, packets are transmitted and received between the transmission apparatus and the other transmission apparatus coupled via the A-PHY I/F defined in the MIPI standard, and an error is inserted in a specific position of a specific transmission packet, out of transmission packets to be transmitted to the other transmission apparatus, based on the first parameter preset.

It is to be noted that the transmission apparatus according to one aspect of the present disclosure may be an independent apparatus or an internal block included in one apparatus.

### BRIEF DESCRIPTION OF THE DRAWINGS

FIG. 1 is a diagram illustrating an exemplary configuration of a transmission system to which the present disclosure is applied, according to one embodiment.

FIG. 2 is a diagram illustrating an exemplary configuration of a transmission unit in the transmission apparatus of FIG. 1.

FIG. 3 is a diagram illustrating a configuration of an A-packet defined in a MIPI standard.

FIG. 4 is a diagram illustrating a relation between an error position and retransmission of the A-packet.

FIG. 5 is a flowchart of an operation of a keep alive controller of FIG. 2.

FIG. 6 is a flowchart of an operation of a fault injection section of FIG. 2.

FIG. 7 is a diagram illustrating an exemplary configuration of a fault injection module.

FIG. 8 is a diagram illustrating an exemplary sequence of error insertion to be performed on a packet transmission side in a MC designation mode during downlink.

FIG. 9 is a diagram illustrating an exemplary sequence of error insertion to be performed on the packet transmission side in a packet count mode during downlink.

FIG. 10 is a diagram illustrating an exemplary sequence of error insertion to be performed on a packet reception side in the MC designation mode during uplink.

FIG. 11 is a diagram illustrating an exemplary sequence of error insertion to be performed on the packet reception side in the packet count mode during uplink.

FIG. 12 is a diagram illustrating an exemplary configuration of the keep alive controller.

FIG. 13 is a diagram illustrating a state machine when a keep alive is enabled.

FIG. 14 is a diagram illustrating a state machine when the keep alive is disabled.

FIG. 15 is a timing chart illustrating input data and output data in the keep alive controller.

FIG. 16 is a diagram illustrating an exemplary configuration of a PCS section on the packet transmission side.

FIG. 17 is a timing chart illustrating input data and output data in the PCS section on the packet transmission side.

FIG. 18 is a diagram illustrating an exemplary configuration of a PCS section on the packet reception side.

FIG. 19 is a timing chart illustrating input data and output data in the PCS section on the packet reception side.

FIG. 20 is a diagram illustrating a configuration in which an existing scheme is employed.

FIG. 21 is a diagram illustrating an example of a packet to be transmitted between the packet transmission side and the packet reception side when the existing scheme is employed.

FIG. 22 is a diagram illustrating an example of a packet to be transmitted between the packet transmission side and the packet reception side when a scheme to which the present disclosure is applied is employed.

FIG. 23 is a diagram illustrating another exemplary configuration of the transmission unit in the transmission apparatus of FIG. 1.

FIG. 24 is a diagram illustrating another exemplary arrangement of the fault injection section.

FIG. 25 is a diagram illustrating still another exemplary arrangement of the fault injection section.

### MODES FOR CARRYING OUT THE INVENTION

### System Configuration

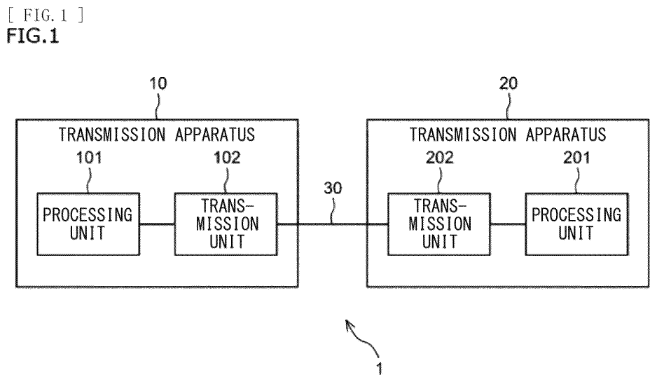

FIG. 1 is a diagram illustrating an exemplary configuration of a transmission system to which the present disclosure is applied, according to an embodiment.

In FIG. 1, a transmission system I includes a transmission apparatus 10 and a transmission apparatus 20. The transmission apparatus 10 and the transmission apparatus 20 exchange data therebetween via a transmission path 30 such as a cable. In the transmission system 1, data transmission via an A-PHY network is performed between the transmission apparatus 10 and the transmission apparatus 20. The A-PHY is a standard for a PHY layer of SerDes for in-vehicle applications, defined in a MIPI alliance. Herein, the standard defined in the MIPI alliance is referred to as a MIPI standard.

The transmission apparatus 10 includes a processing unit 101 and a transmission unit 102. The processing unit 101 includes, for example, a chip that performs processing related to a protocol adaptation layer (PAL), and a central processing unit (CPU) that controls an operation of each component of the transmission apparatus 10. The transmission unit 102 includes, for example, a chip that performs processing related to data transmission. The transmission unit 102 performs processing related to the A-PHY (processing of the PHY layer and a data link layer). The processing unit 101 performs processing related to a higher layer which is an upper layer of the A-PHY.

The transmission apparatus 20 includes a processing unit 201 and a transmission unit 202. The processing unit 201 includes, for example, a chip that performs processing related to the PAL, and a CPU that controls an operation of each component of the transmission apparatus 20. The transmission unit 202 includes, for example, a chip that performs processing related to data transmission. The transmission unit 202 performs processing related to the A-PHY. The processing unit 201 performs processing related to a higher layer which is an upper layer of the A-PHY.

In the transmission system 1, one of the transmission apparatus 10 and the transmission apparatus 20 coupled to each other via the A-PHY I/F serves as a source, and the other serves as a sink. The source and the sink are defined in the MIPI standard. In an example described below, the transmission apparatus 10 serves as the source, and the transmission apparatus 20 serves as the sink. Transmission from the source to the sink is referred to as downlink (DL), and transmission from the sink to the source is referred to as uplink (UL). The downlink and the uplink are different from each other in transmission speed (communication speed). The downlink is higher in speed than the uplink.

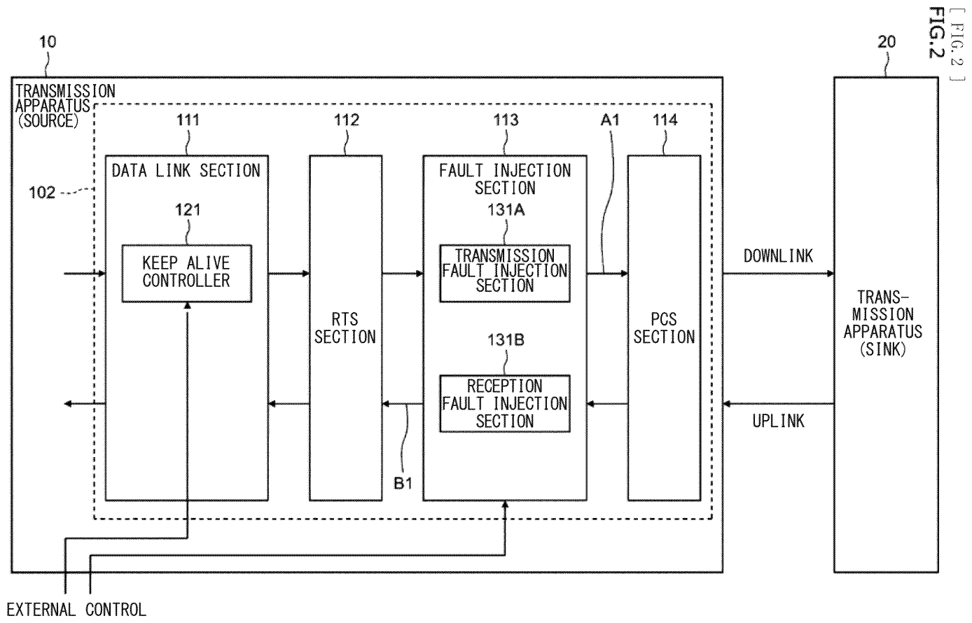

FIG. 2 is a diagram illustrating an exemplary configuration of the transmission unit 102 in the transmission apparatus 10 of FIG. 1. In FIG. 2, the transmission unit 102 includes a data link section 111, a RTS section 112, a fault injection section 113, and a PCS section 114.

The data link section 111 performs processing related to a data link layer (hereinafter referred to as data link processing). The data link section 111 includes a keep alive controller 121 that transmits a keep alive packet when a packet including valid data is not transmitted in a predetermined time period. The RTS section 112 performs processing related to retransmission (RTS) (hereinafter referred to as RTS processing). The fault injection section 113 performs processing of inserting an error in a specific packet. The fault injection section 113 includes a transmission fault injection section 131A and a reception fault injection section 131B as error insertion sections. The PCS section 114 performs processing related to a physical coding sublayer (PCS) (hereinafter referred to as PCS processing).

In packet transmission, packets outputted from the processing unit 101 in the transmission apparatus 10 are inputted to the transmission unit 102. The data link section 111 performs the data link processing on the packets received from the processing unit 101, and supplies the resultant packets to the RTS section 112. The RTS section 112 performs the RTS processing on the packets supplied from the data link section 111, and supplies the resultant packets to the fault injection section 113. In the fault injection section 113, the transmission fault injection section 131A inserts an error in a specific packet, out of the packets to be transmitted, based on a preset parameter. The PCS section 114 performs the PCS processing on the packets supplied from the fault injection section 113.

In the packet transmission, the packets are transmitted from the transmission apparatus 10 to the transmission apparatus 20 through the downlink. In the transmission apparatus 10, the transmission fault injection section 131A inserts an error in a specific packet, out of packets to be transmitted (the error is inserted at a position indicated by an arrow Al in FIG. 2); therefore, the transmission apparatus 20 receives the packet in which the error is inserted.

In packet reception, the transmission apparatus 10 receives packets transmitted from the transmission apparatus 20 through the uplink, and the packets are inputted to the PCS section 114. The PCS section 114 performs the PCS processing on the packets received at the PCS section 114, and supplies the resultant packets to the fault injection section 113. In the fault injection section 113, the reception fault injection section 131B inserts an error in a specific packet, out of the packets received, based on a preset parameter. The RTS section 112 performs the RTS processing on the packets supplied from the fault injection section 113, and supplies the resultant packets to the data link section 111. The data link section 111 performs the data link processing on the packets received from the RTS section 112, and outputs the resultant packets to the processing unit 101.

In the packet reception, the packets are transmitted from the transmission apparatus 20 to the transmission apparatus 10 through the uplink. In the transmission apparatus 10, the reception fault injection section 131B inserts an error in a specific packet out of the packets properly received (the error is inserted at a position indicated by an arrow BI in FIG. 2).

In the transmission apparatus 10 having the configuration described above, the transmission unit 102 includes the fault injection section 113, and the transmission fault injection section 131A is configured to insert an error in a specific transmission packet in the downlink. Further, the reception fault injection section 131B is configured to insert an error in a specific reception packet in the uplink. It is to be noted that the keep alive controller 121 and the fault injection section 113 in the transmission apparatus 10 may be externally controlled using a register or the like.

### Configuration of A-Packet

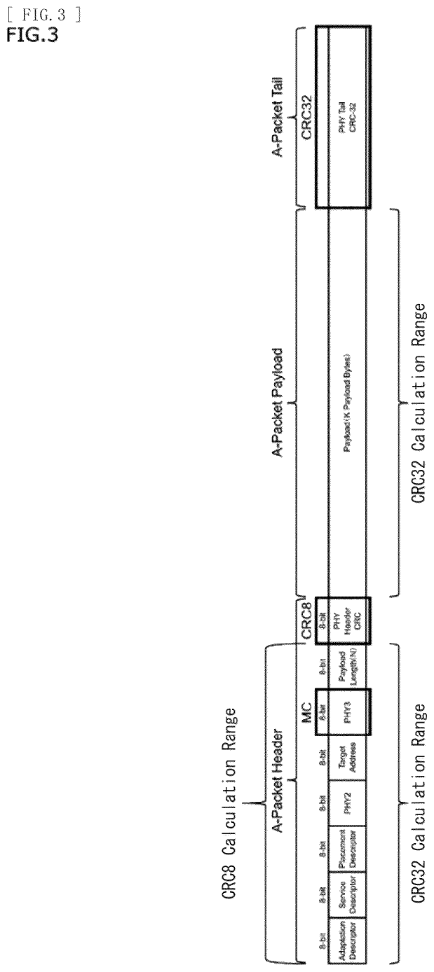

In the transmission system 1, an A-packet defined in the MIPI standard is transmitted and received between the transmission apparatus 10 and the transmission apparatus 20 during serial communication. FIG. 3 is a diagram illustrating a configuration of the A-packet defined in the MIPI standard. In FIG. 3, the A-packet includes an A-packet header, an A-packet payload, and an A-packet tail.

The A-packet header includes fields of an adaptation descriptor of 8 bits, a service descriptor of 8 bits, a placement descriptor of 8 bits, a PHY2 of 8 bits, a target address of 8 bits, a PHY3 of 8 bits, a payload length of 8 bits, and a PHY header CRC of 8 bits. A message counter (MC) number is added to the PHY3 in the RTS section 112 in transmitting the A-packet. For example, the MC number takes a value from 0 to 255, and different MC numbers are added to the A-packets. In this example, the MC number starts from 0, is incremented for each A-packet, and returns to 0 after becoming 255. This allows all the A-packets to be assigned with the MC numbers.

The PHY header CRC of the A-packet header is a field for cyclic redundancy check (CRC) to which CRC8 inspection data is to be added. A calculation range of the CRC8 is the A-packet header. The A-packet tail includes a filed of a PHY tail CRC-32. The PHY tail CRC-32 is a field for the CRC to which CRC32 inspection data is to be added. A calculation range of the CRC32 is the A-packet header and the A-packet payload.

On an A-packet transmission side, a predetermined calculation is performed on data of the A-packet to be transmitted, and a value obtained as a result of the calculation is added as inspection data to the A-packet. In contrast, on an A-packet reception side, a predetermined calculation is performed on the received A-packet, and a determination is made as to whether a value obtained as a result of the calculation is equal to a value of the inspection data added to the A-packet. If the values are equal to each other, the transmitted data is correct. If the values are not equal to each other, the transmitted data includes an error; therefore, the error of the A-packet is detectable on the a-packet reception side.

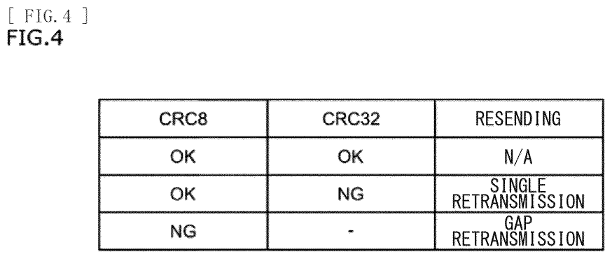

FIG. 4 is a diagram illustrating a relation between an error position and retransmission of the A-packet. As illustrated in FIG. 4, a determination as to whether the retransmission is to be performed is made, based on a combination of the detection results of the CRC8 and the CRC32. If an error is detected neither from the CRC8 nor the CRC32, the A-packet has been transmitted properly, and it is thus determined that the retransmission is not to be performed. If no error is detected in the CRC8 but an error is detected in the CRC32, single retransmission is to be performed. If an error is detected in the CRC8, gap retransmission is to be performed without detecting an error in the CRC32. In this way, on the A-packet reception side, the error detection is performed on the A-packet in terms of the CRC8 and the CRC32 having different calculation ranges, and two kinds of retransmission are performed depending on the detected error position.

The transmission fault injection section 131A in the transmission apparatus 10 is configured to, in the A-packet transmission, insert an error in a specific position of a specific A-packet out of the A-packets to be transmitted. The transmission fault injection section 131A is configured to insert an error in the specific position by changing a CRC value (CRC inspection data) of the CRC8 or the CRC32 added to the A-packet to be transmitted. Alternatively, the transmission fault injection section 131A may change a value of a target portion which is the calculation range of the CRC in the A-packet to be transmitted. In a case of the CRC8, for example, a value of the A-packet header may be changed. In a case of the CRC32, a value of the A-packet payload may be changed. Both the CRC value and the value of the target portion which is the calculation range of the CRC may be changed.

Further, the reception fault injection section 131B in the transmission apparatus 10 is configured to, in the A-packet reception, insert an error in a specific position of a specific A-packet out of the A-packets received. Like the transmission fault injection section 131A, the reception fault injection section 131B is configured to change the CRC value of the CRC8 or the CRC 32 added to the normal A-packet having been received, or change the value of the target portion which is the calculation range of the CRC.

### Flow of Operation

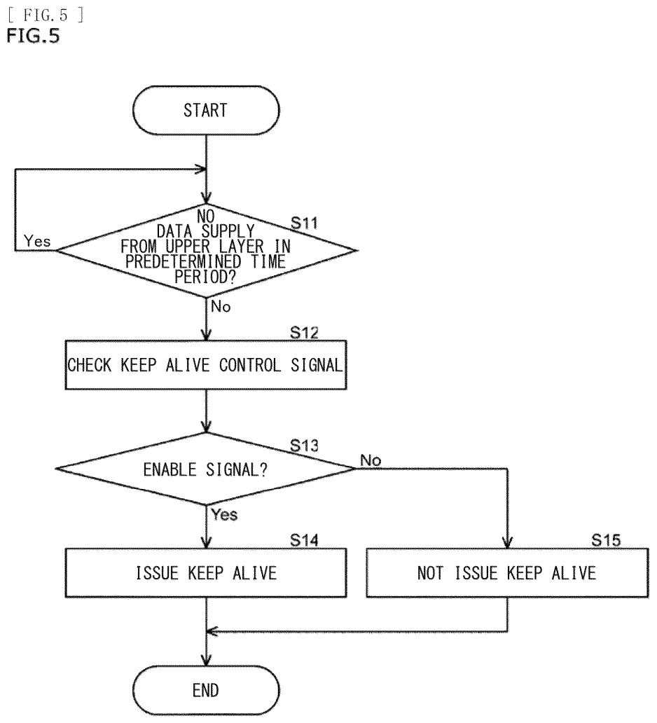

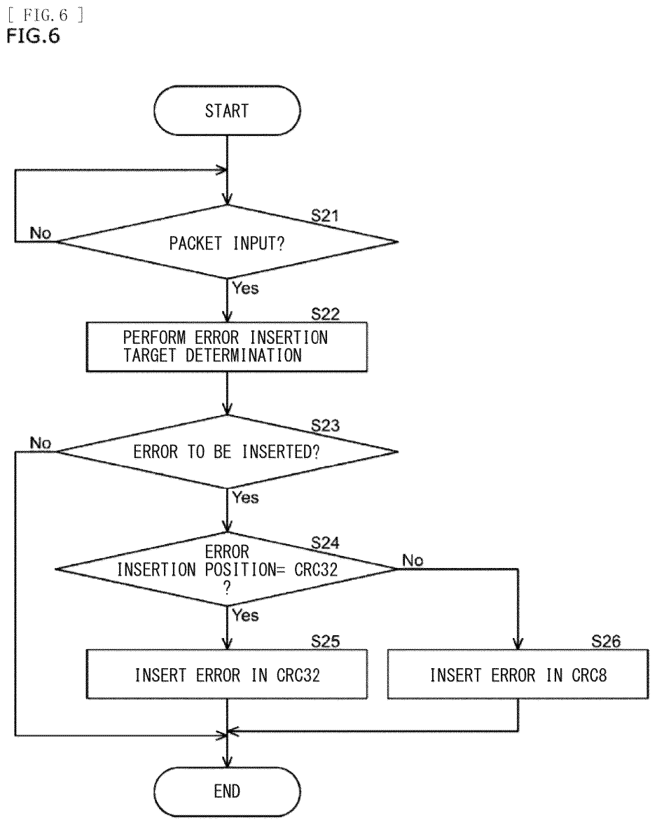

A description will be given, with reference to FIGS. 5 and 6, of an operation of packet error insertion in the transmission apparatus 10 of FIG. 2. A flowchart of FIG. 5 illustrates an operation of the keep alive controller 121 in the data link section 111 of FIG. 2. If no data (valid data such as image data) is supplied from the processing unit 101 that performs the processing on the upper layer in a predetermined time period (in 5.5 μs defined in a MIPI A-PHY standard) (S11: Yes), the keep alive controller 121 checks a keep alive control signal (keep alive enable/disable signal) received from an external device (S12).

If the keep alive control signal is an enable signal (S13: Yes), the keep alive controller 121 issues a keep alive (S14). For example, the keep alive controller 121 generates a keep alive packet, and performs control to transmit the keep alive packet to the transmission apparatus 20. In contrast, if the keep alive control signal is a disable signal (S13: No), the keep alive controller 121 refrains from issuing the keep alive (S15). That is, the keep alive controller 121 performs control to stop the keep alive packet. Although described in detail below, identification and control of the MC number of the A-packet are facilitated by stopping the keep alive packet in evaluating the packet retransmitting function (that is, in error insertion in the A-packet by the fault injection section 113).

A flowchart of FIG. 6 illustrates an operation of the transmission fault injection section 131A in the fault injection section 113 of FIG. 2. If the A-packet to be transmitted is inputted (S21: Yes), the transmission fault injection section 131A makes an error insertion target determination on the received A-packet, based on a preset parameter (S22). If an error is to be inserted in the A-packet (S23: Yes), the transmission fault injection section 131A determines whether an error insertion position is the CRC32, based on the preset parameter (S24).

If the error insertion position is the CRC32 (S24: Yes), the transmission fault injection section 131A inserts an error in the CRC32 of the A-packet to be transmitted (S25). Here, the CRC value of the CRC32 added to the A-packet to be transmitted is changed, or the value of the A-packet payload corresponding to the calculation range of the CRC32 is changed. In contrast, if the error insertion position is the CRC8 (S24: No), the transmission fault injection section 131A inserts an error in the CRC8 of the A-packet to be transmitted (S26). Here, the CRC value of the CRC8 added to the A-packet to be transmitted is changed, or the value of the A-packet header corresponding to the calculation range of the CRC8 is changed.

It is to be noted that, although the transmission fault injection section 131A inserts the error in the A-packet to be transmitted in the description of FIG. 6, the same error insertion processing is performed also when the reception fault injection section 131B inserts an error in the received A-packet, except that the A-packet in which an error is to be inserted is a received A-packet rather than an A-packet to be transmitted.

### Configuration of Fault Injection

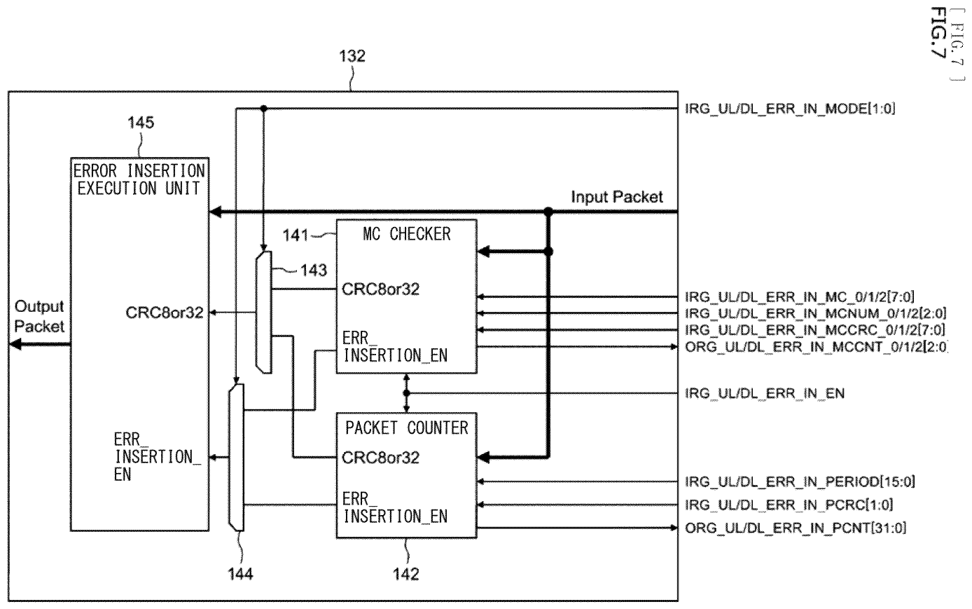

FIG. 7 is a diagram illustrating an exemplary configuration of a fault injection module 132. The fault injection module 132 is included in each of the transmission fault injection section 131A and the reception fault injection section 131B of FIG. 2. In FIG. 7, the fault injection module 132 includes a MC checker 141, a packet counter 142, a selector 143, a selector 144, and an error insertion execution unit 145.

The MC checker 141, the packet counter 142, and the error insertion execution unit 145 receive packets (transmission packets or a reception packets) from a preceding stage. The selector 143 and the selector 144 receives a parameter, “IRG_UL/DL_ERR_IN_MODE”. The parameter “IRG_UL/DL_ERR_IN_MODE” designates 0 or 1. When 0 is designated, a MC designation mode is in effect, while when 1 is designated, a packet count mode is in effect. The MC designation mode is a mode in which the MC number of a specific packet (transmission packet or reception packet) is designated, and an error is inserted in a specific position of the specific packet based on the type (CRC8 or CRC32) of the error. The packet counter mode is a mode in which an error is inserted in a specific position of a specific packet (transmission packet or reception packet) when the number of packets has reached a predetermined number of packets (transmission packets or reception packets), based on the type of the error (CRC8 or CRC32).

The MC checker 141 receives parameters IRG_UL/DL_ERR_IN_EN, IRG_UL/DL_ERR_IN MC, IRG_UL/DL_ERR_IN_MCNUM, and IRG_UL/DL_ERR_IN_MCCRC″. The parameter, IRG_UL/DL_ERR_IN_EN designates 0 or 1. When 0 is designated, a disabled state is in effect, while when 1 is designated, an enabled state is in effect. The parameter, IRG_UL/DL_ERR_IN_MC is a parameter that designates an error insertion MC number that is the MC number of a specific packet in which an error is to be inserted. The parameter, IRG_UL/DL_ERR_IN_MC is valid only in the MC designation mode.

The parameter, IRG_UL/DL_ERR_IN_MCNUM is a parameter that designates a maximum error insertion number that is a maximum number of errors to be inserted in the specific packet. For example, when the parameter, IRG_UL/DL_ERR_IN_MCNUM is 0, no error is to be inserted; when the parameter, IRG_UL/DL_ERR_IN_MCNUM is 1, an error is to be inserted only in an original packet; when the parameter, IRG_UL/DL_ERR_IN_MCNUM is 2, an error is to be inserted in the original packet and a first retransmitting packet; when the parameter, IRG_UL/DL_ERR_IN_MCNUM is 3, an error is to be inserted in the original packet, the first retransmitting packet, and a second retransmitting packet. Further, when the parameter, IRG_UL/DL_ERR_IN_MCNUM is 7, an error is to be inserted in the original packet and all the retransmitting packets. The parameter, IRG_UL/DL_ERR_IN_MCCRC is a parameter that designates a kind of error to be inserted in the specific packet. For example, the parameter, IRG_UL/DL_ERR_IN_MCCRC designates 0 or 1. When 0 is designated, the CRC32 is set, while when 1 is designated, the CRC8 is set.

Based on the parameters, the MC checker 141 checks the packet inputted (transmission packet or reception packet), and when the specific packet is inputted, outputs an ERR insertion EN indicating error insertion, to the selector 144. At this time, the MC checker 141 outputs the kind of error CRC8 or CRC32 as the kind of error to be inserted in the specific packet, to the selector 143. In addition, the MC checker 141 outputs a parameter, ORG_UL/DL_ERR_IN_MCCNT indicating the number of errors inserted in the MC designation mode.

The packet counter 142 receives parameters IRG_UL/DL_ERR_IN_EN, IRG_UL/DL_ERR_IN PERIOD, and IRG_UL/DL_ERR_IN_PCRC″. The parameter, IRG_UL/DL_ERR_IN_PERIOD designates an error insertion counter value that is a counter value depending on the frequency of insertion of an error in the specific packet. The parameter, IRG_UL/DL_ERR_IN_PCRC designates the kind of error to be inserted in the specific packet. For example, the parameter, IRG_UL/DL_ERR_IN_PCRC designates 0, 1, or 2. When 0 is designated, the CRC32 is set, when 1 is designated, the CRC8 is set, and when 2 is designated, the CRC32 and the CRC8 are alternately set. The parameters, IRG_UL/DL_ERR_IN_PERIOD and IRG_UL/DL_ERR_IN_PCRC are valid only in the packet count mode.

Based on the parameters, the packet counter 142 counts the packets to be inputted (transmission packets and reception packets). When the counted value becomes equal to the error insertion counter value, the packet counter 142 outputs the ERR_insertion_EN indicating the insertion of an error to the selector 144. At this time, the packet counter 142 outputs the kind of error CRC8 or CRC32 as the kind of error to be inserted in the specific packet, to the selector 143. In addition, the packet counter 142 outputs a parameter, ORG_UL/DL_ERR_IN_PCNT indicating the number of errors inserted in the packet count mode.

The selector 143 receives the kind of error from the MC checker 141 and the kind of error from the packet counter 142. The selector 143 selects one of these inputs corresponding to the mode designated by the parameter, IRG_UL/DL_ERR_IN_MODE, and outputs the kind of error CRC8 or CRC32 to the error insertion execution unit 145. Specifically, when the MC designation mode is designated, the selector 143 outputs the kind of error received from the MC checker 141 to the error insertion execution unit 145, while when the packet count mode is designated, the selector 143 outputs the kind of error received from the packet counter 142 to the error insertion execution unit 145.

The selector 144 receives the ERR insertion EN from the MC checker 141 and the ERR_insertion_EN from the packet counter 142. The selector 144 selects one of these inputs corresponding to the mode designated by the parameter, IRG_UL/DL ERR IN MODE, and outputs the selected ERR_insertion_EN to the error insertion execution unit 145. Specifically, when the MC designation mode is designated, the selector 144 outputs the ERR_insertion EN received from the MC checker 141 to the error insertion execution unit 145, while when the packet count mode is designated, the selector 144 outputs ERR_insertion_EN received from the packet counter 142 to the error insertion execution unit 145.

The error insertion execution unit 145 receives the kind of error from the selector 143 and the ERR_insertion_EN from the selector 144 in synchronization with a packet inputted from a preceding stage. The error insertion execution unit 145 outputs the input packet as an output packet to a subsequent stage. When the ERR_insertion_EN is inputted, the error CRC8 or CRC32 indicated by the kind of error is inserted in the input packet, and the output packet in which the error is inserted is outputted. For example, an error insertion method includes changing the value of the CRC added to the input packet or changing the value of a CRC calculation target portion. In a case of the latter insertion method, the value of the header portion may be changed when the kind of error is the CRC8, or the value of the payload portion may be changed when the kind of error is the CRC32.

The transmission fault injection section 131A or the reception fault injection section 131B including the fault injection module 132 having the above-described configuration is configured to insert an error in a specific position of a specific packet, out of input packets, depending on the modes including the MC designation mode and the packet count mode. That is, in the MC designation mode, an error is insertable in a specific position, corresponding to the kind of error CRC8 or CRC32, of a specific packet to which the MC number indicated by the error insertion MC number designated by the parameter is added. Further, in the packet count mode, the input packets are counted, and when the counted value becomes equal to the error insertion counter value designated by the parameter, an error is insertable in a specific position, corresponding to the kind of error CRC8 or CRC32, of a specific packet.

The parameters such as IRG_UL/DL_ERR_IN_MC, IRG_UL/DL_ERR_IN_MCNUM, or IRG_UL/DL_ERR_IN_MCCRCMC used in the designation mode and the parameters such as IRG_UL/DL_ERR_IN_PERIOD or IRG_UL/DL_ERR_IN_PCRC used in the packet count mode may be designated by the user, and may be set based on an input to the register; however, another setting method may be employed. It is to be noted that “UL” and “DL” in UL/DL of each parameter represent uplink and downlink, respectively.

### Exemplary Evaluation of Packet Retransmitting Function

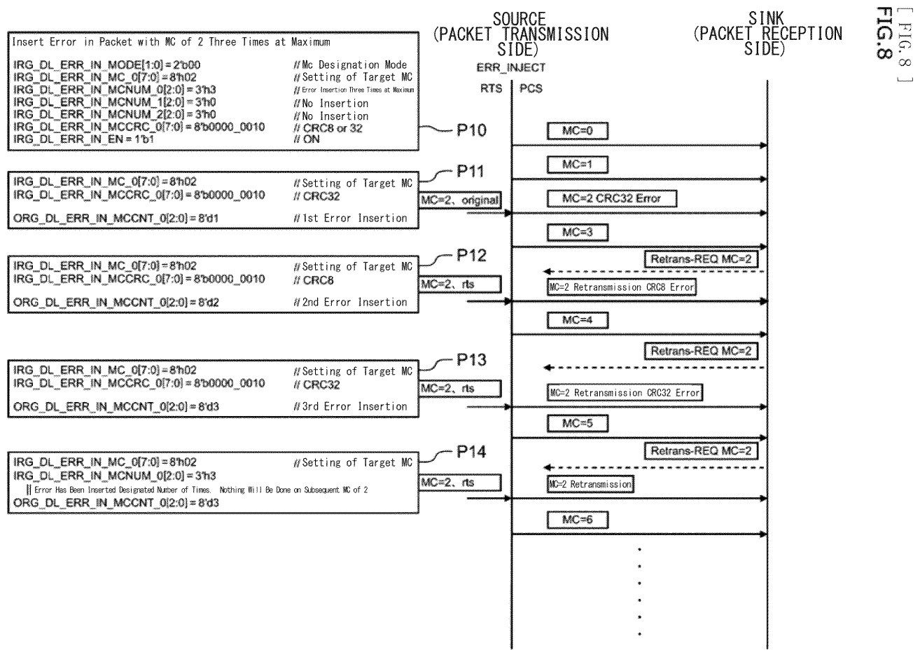

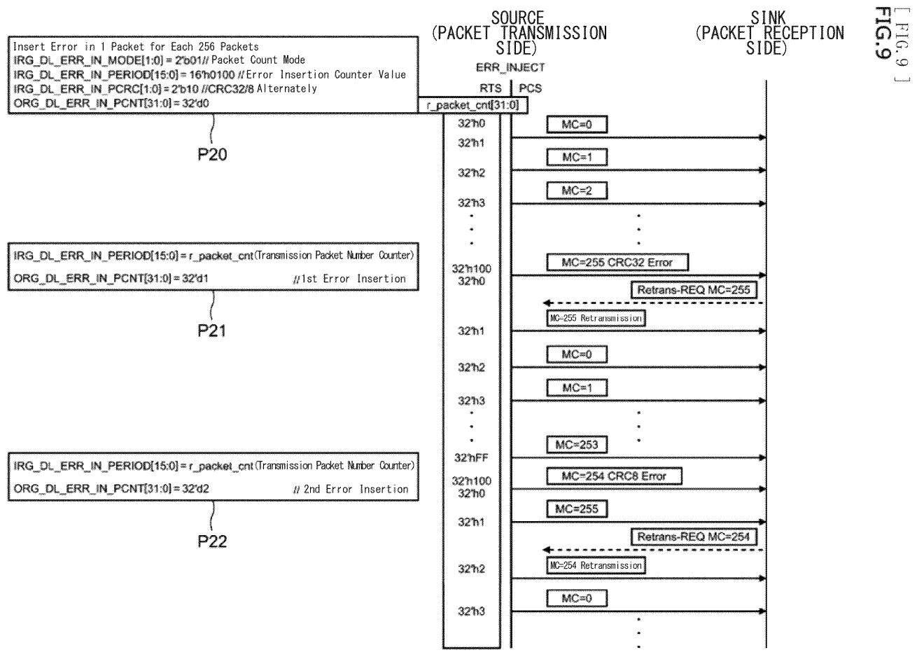

Next, a description is given, with reference to sequences of FIGS. 8 to 11, of a specific example of a packet to be transmitted and received between the transmission apparatus 10 and the transmission apparatus 20. In an example of FIGS. 8 and 9, the transmission apparatus 10 which is a source corresponds to a packet transmission side, the transmission apparatus 20 which is a sink corresponds to a packet reception side, and packet transmission is performed through downlink (DL). In this case, in the transmission apparatus 10 which is a source, error insertion in a specific transmission packet is performed by the transmission fault injection section 131A.

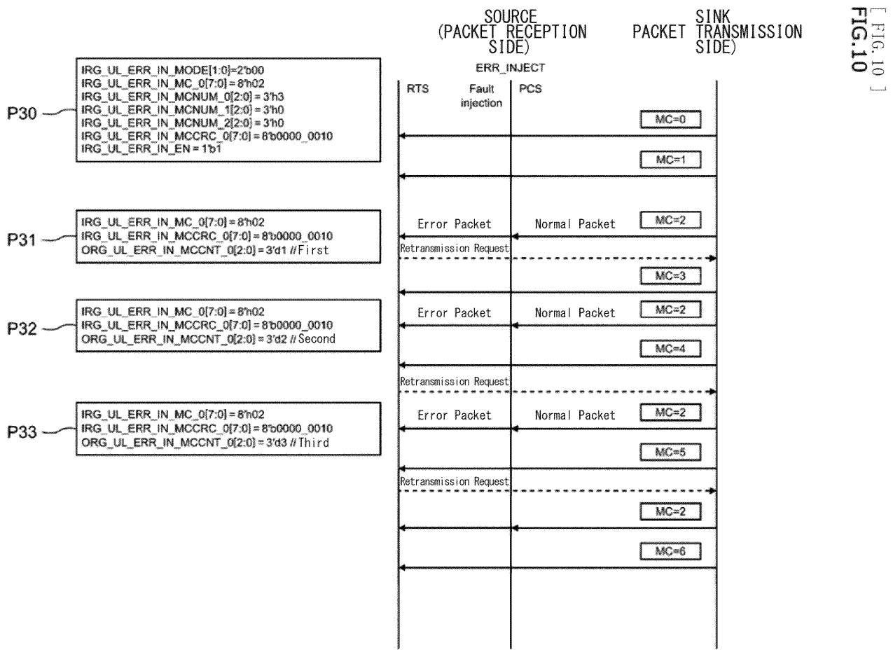

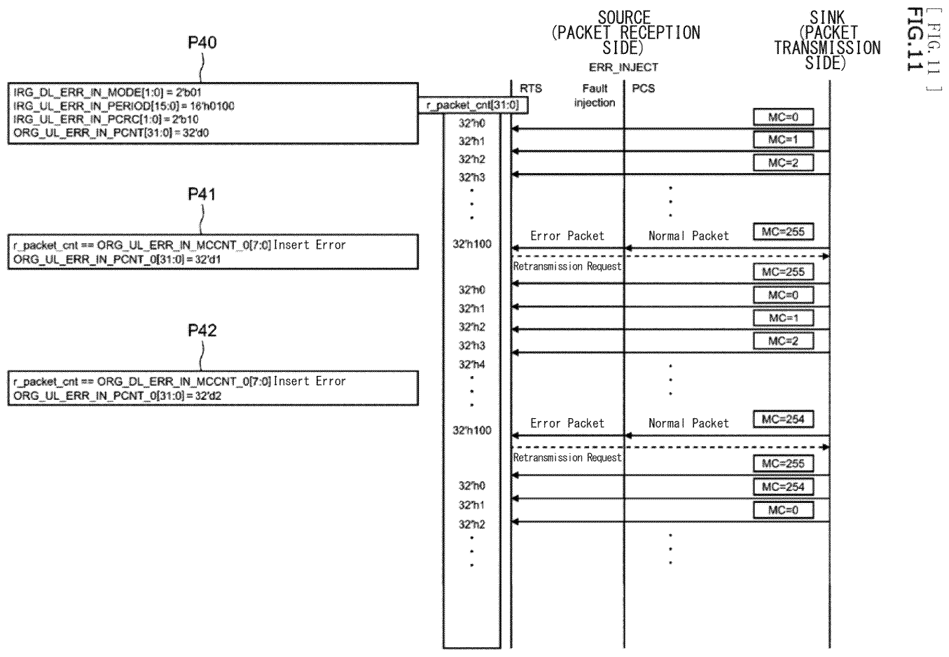

In an example of FIGS. 10 and 11, the transmission apparatus 20 which is a sink corresponds to a packet transmission side, the transmission apparatus which is a source corresponds to a packet reception side, and packet transmission is performed through uplink. In this case, in the transmission apparatus 10 which is a source, error insertion in a specific reception packet is performed by the reception fault injection section 131B. It is to be noted that, in the following description, an A-packet with the MC number of i is described as a packet #i: for example, an A-packet with the MC number of 0 is described as a packet #0, an A-packet with the MC number of 1 is described as a packet #1, and an A-packet with the MC number of 2 is described as a packet #2.

### First Example

FIG. 8 is a diagram illustrating an exemplary sequence of the error insertion to be performed on the packet transmission side in the MC designation mode during the downlink In the example of FIG. 8, an error is inserted in the packet #2 three times at a maximum, and the following parameters are set, for example (P10). For instance, the MC designation mode is designated by a parameter, IRG_DL_ERR_IN_MODE=2′b00, the MC number of 2 is designated as the error insertion MC number by a parameter, IRG_DL_ERR_IN_MC=8′h02, and the maximum error insertion number of 3 is designated by a parameter, IRG_DL_ERR_IN_MCNUM=3′h03. Further, the kind of error CRC32 or CRC8 is designated by a parameter, IRG_DL_ERR_IN_MCCRC=8′b0000_0010. Here, the lower 3 bits each indicate the kind of error to be used in the first to third error insertion: when 0 is designated, the kind of error is set as CRC32, and when 1 is designated, the kind of error is set as CRC8. Accordingly, CRC32, CRC8, CRC32 are designated in order.

When the transmission apparatus 10 transmits the packet #2 after transmitting the packet #0 and the packet #1, the transmission fault injection section 131A inserts the error CRC32 in the first error insertion (P11). After transmitting the packet #3, the transmission apparatus 10 receives a request for retransmitting the packet #2 transmitted from the transmission apparatus 20. In retransmitting the packet #2 in response to the request, the transmission fault injection section 131A inserts the error CRC8 in the second error insertion (P12). After transmitting the packet #4, the transmission apparatus 10 receives a request for retransmitting the packet #2 transmitted from the transmission apparatus 20. In retransmitting the packet #2 in response to the request, the transmission fault injection section 131A inserts the error CRC32 in the third error insertion (P13).

Thereafter, after transmitting the packet #5, the transmission apparatus 10 receives a request for retransmitting the packet #2 transmitted from the transmission apparatus 20, and retransmits the packet #2 in response to the request (P14). At this time, the error insertion has been performed on the packet #2 three times, which means that the designated number of errors have been inserted; therefore, nothing will be done (no error is inserted) on the subsequent packet #2 to be retransmitted.

In this way, in the case of the error insertion on the packet transmission side in the MC designation mode during the downlink, it is possible to intentionally generate an error, for example, on a condition that the error insertion in the packet #2 is performed three times, by setting the parameters such as IRG_DL_ERR_IN_MC and IRG_DL_ERR_IN_MCNUM. This makes it possible to achieve reproducible evaluation of the retransmitting function.

### Second Example

FIG. 9 is a diagram illustrating an exemplary sequence of the error insertion to be performed on the packet transmission side in the packet count mode during the downlink. In the example of FIG. 9, an error is inserted in 1 packet for each 256 packets, and the following parameters are set, for example (P20). For instance, the packet count mode is designated by a parameter, IRG_DL_ERR_IN_MODE=2′b01, and the error insertion counter value for the error insertion in 1 packet for each 256 packets is designated by a parameter, IRG_DL_ERR_IN PERIOD=16′h0100. Further, the kinds of errors CRC32 and CRC8 are alternately designated by a parameter, IRG_DL_ERR_IN_PCRC=2′b10.

The transmission apparatus 10 transmits the packet #0, the packet #1, . . . in order while updating the counter value (r_packet_cnt) of the number of the transmission packets. In transmitting a packet #255, the counter value reaches the error insertion counter value of 256, and the transmission fault injection section 131A inserts the error CRC32 in the packet #255 in the first error insertion (P21). At this time, the counter value is reset. If a request for retransmitting the packet #255 is received from the transmission apparatus 20 after the packet #255 is transmitted, the transmission apparatus 10 retransmits the packet #255 in response to the request.

Thereafter, the transmission apparatus 10 transmits the packet #0, the packet #1 . . . in order while updating the counter value again. In transmitting a packet #254, the counter value reaches 256, and the transmission fault injection section 131A inserts the error CRC8 in the packet #254 in the second error insertion (P22). At this time, the counter value is reset. If a request for retransmitting the packet #254 is received from the transmission apparatus 20 after the packet #255 is transmitted, the transmission apparatus 10 retransmits the packet #254 in response to the request. Thereafter, when the counter value reaches 256, an error is inserted in a corresponding transmission packet, in the same manner as described above.

In this way, in the case of the error insertion on the packet transmission side in the packet count mode during the downlink, it is possible to intentionally generate an error, for example, on the condition that the error insertion is performed on 1 packet for each 256 packets (at a predetermined frequency), by setting the parameter such as IRG_DL_ERR_IN_PERIOD. This makes it possible to achieve reproducible evaluation of the retransmitting function.

### Third Example

FIG. 10 is a diagram illustrating an exemplary sequence of the error insertion to be performed on the packet reception side in the MC designation mode during the uplink. In the example of FIG. 10, an error is inserted in the packet #2 three times at a maximum, and the following parameters are set, for example (P30). For instance, the MC designation mode is designated by a parameter, IRG_UL_ERR_IN_MODE=2′b00, the MC number of 2 is designated as the error insertion MC number by a parameter, RG_UL_ERR_IN_MC=8′h02, the maximum error insertion number of 3 is designated by a parameter, IRG_UL_ERR_IN_MCNUM=3h 03, and the kinds of errors CRC32 or CRC8 are designated by a parameter, IRG_UL_ERR_IN_MCCRC=8′b0000_0010.

When the transmission apparatus 10 receives the packet #2 after receiving the packet #0 and the packet #1 transmitted from the transmission apparatus 20, the reception fault injection section 131B inserts the error CRC32 in the normal packet #2 having been received, in the first error insertion (P31). In the transmission apparatus 10, the RTS section 112 processes the packet #2 which has been properly received and to which the error has been inserted as an error packet, and transmits a request for retransmitting the packet #2 to the transmission apparatus 20.

When the transmission apparatus 10 receives the packet #2 retransmitted in response to the request for retransmitting after receiving the packet #3 transmitted from the transmission apparatus 20, the reception fault injection section 131B inserts the error CRC8 in the normal packet #2 having been received, in the second error insertion (P32). In the transmission apparatus 10. the RTS section 112 transmits a request for retransmitting the packet #2.

When the transmission apparatus 10 receives the packet #2 retransmitted in response to the request for retransmitting after receiving the packet #4 transmitted from the transmission apparatus 20, the reception fault injection section 131B inserts the error CRC32 in the normal packet #2 having been received, in the third error insertion (P33). After the transmission apparatus 10 receives the packet #5 transmitted from the transmission apparatus 20, the RTS section 112 transmits the request for retransmitting the packet #2. Thereafter, the transmission apparatus 10 receives the packet #2 retransmitted in response to the request for retransmitting; however, the error insertion has been already performed on the packet #2 three times, which means that the designated number of errors have been inserted. Therefore, nothing will be done (no error is inserted) on the subsequent packet #2 to be received.

In this way, in the case of the error insertion on the packet transmission side in the MC designation mode during the uplink, it is possible to intentionally generate an error, for example, on a condition that the error insertion in the packet #2 is performed three times, by setting the parameters such as IRG_UL_ERR_IN_MC, and IRG_UL_ERR_IN_MCNUM. This makes it possible to achieve reproducible evaluation of the retransmitting function.

### Fourth Example

FIG. 11 is a diagram illustrating an exemplary sequence of the error insertion to be performed on the packet reception side in the packet count mode during the uplink. In the example of FIG. 11, an error is inserted in 1 packet for each 256 packets, and the following parameters are set, for example (P40). For instance, the packet count mode is designated by a parameter, IRG_UL_ERR_IN_MODE=2′b01, the error insertion counter value for the error insertion in 1 packet for each 256 packets is designated by a parameter, IRG_UL_ERR_IN_PERIOD=16′h0100, and the kinds of errors CRC32 and CRC8 are alternately designated by a parameter, IRG_UL_ERR_IN_PCRC=2′b10.

The transmission apparatus 10 receives the packet #0, the packet #1, . . . in order while updating the counter value (r_packet_cnt) of the number of the reception packets. In receiving the packet #255, the counter value reaches the error insertion counter value 256; therefore, the reception fault injection section 131B inserts the error CRC32 in the packet #255 in the first error insertion (P41). At this time, the counter value is reset. In the transmission apparatus 10, the RTS section 112 processes the packet #2 which has been properly received and to which the error has been inserted as an error packet, and transmits a request for retransmitting the packet #255 to the transmission apparatus 20. Accordingly, the transmission apparatus 10 receives the packet #255 retransmitted from the transmission apparatus 20.

Thereafter, the transmission apparatus 10 receives the packet #0, the packet #1, . . . in order again while updating the counter value. In receiving the packet #254, the counter value reaches 256; therefore, the reception fault injection section 131B inserts the error CRC8 in the packet #254 in the second error insertion (P42). In the transmission apparatus 10, the RTS section 112 transmits a request for retransmitting the packet #254. Accordingly, the transmission apparatus 10 receives the packet #254 retransmitted in response to the request for retransmitting, after receiving the packet #255 transmitted from the transmission apparatus 20. Thereafter, when the counter value reaches 256, an error is inserted in a corresponding reception packet, in the same manner as described above.

In this way, in the case of the error insertion on the packet reception side in the packet count mode during the uplink, it is possible to intentionally generate an error, for example, on the condition that the error insertion is performed on 1 packet for 256 packets (at a predetermined frequency), by setting the parameter such as IRG_UL_ERR_IN_PERIOD. This makes it possible to achieve reproducible evaluation of the retransmitting function.

### Keep Alive Control

The MIPI A-PHY standard stipulates that a keep alive packet is transmitted when no packet including valid data such as image data is transmitted for 5.5 ps. The keep alive packet is a packet to check whether the communication is properly performed, and its content itself has no meaning When the keep alive packet is to be transmitted, it is difficult to specify which MC number is added to the A-packet including the valid data. That is, when the MC designation mode is designated, it is sometimes difficult to achieve reproducible evaluation of the content of the A-packet. In the present disclosure, the generation (transmission) of the keep alive packet is controllable between an enabled state and a disabled state. This allows the MC number added to the A-packet including valid data to be easily specified, and allows the content of the packet to have reproducibility.

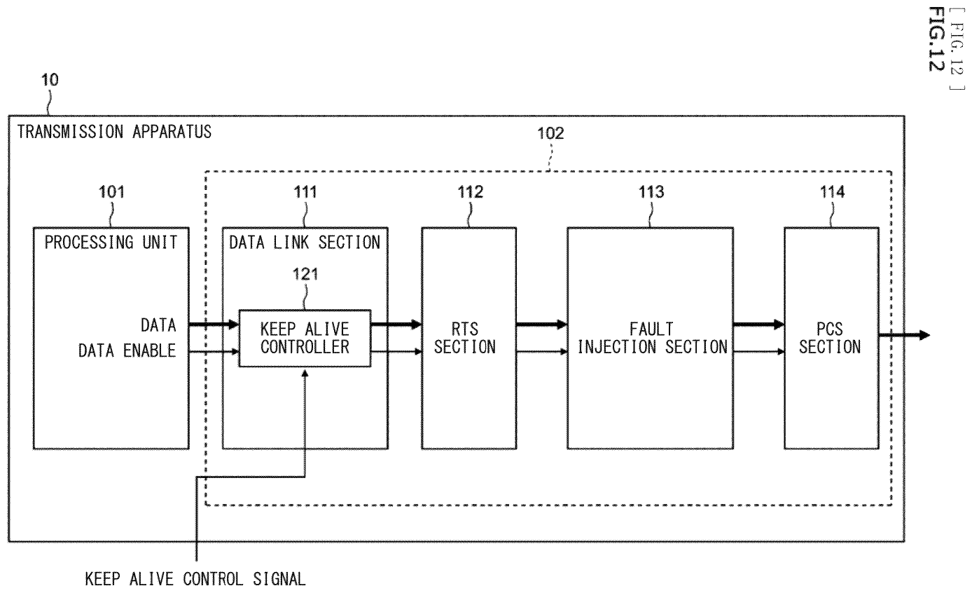

As illustrated in FIG. 12, in the transmission apparatus 10, the transmission unit 102 processes the data received from the processing unit 101. In the transmission unit 102, when no packet including valid data is transmitted for 5.5 μs, the keep alive controller 121 in the data link section 111 generates the keep alive packet. In FIG. 12, the keep alive is switchable between the enabled state and the disabled state by inputting a keep alive control signal (keep alive enable/disable signal) to the keep alive controller 121 under external control. For example, when the keep alive control signal of a level H is inputted, the keep alive controller 121 is brought into the enabled state. When no valid data is transmitted for 5.5 μs, the keep alive controller 121 generates a keep alive packet. Further, when the keep alive control signal of a level L is inputted, the keep alive controller 121 is brought into the keep alive disabled state. Even when no valid data is transmitted for 5.5 μs, the keep alive controller 121 generates no keep alive packet and stops the keep alive packet.

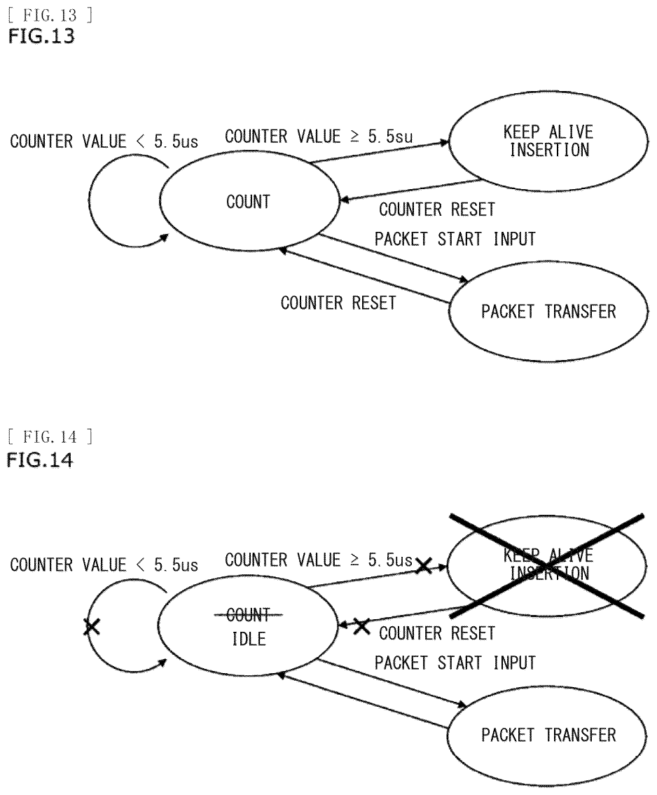

FIG. 13 is a diagram illustrating an exemplary state machine when the keep alive is enabled. As illustrated in FIG. 13, when the keep alive is enabled, there are three states: a count state in which time is counted, a keep alive insertion state in which a keep alive packet is generated and outputted to a subsequent stage, and a packet transfer state in which a packet received from an upper layer is outputted to the subsequent stage. When the keep alive is enabled, time is counted in the count state, and when the counter value reaches 5.5 μs, the count state transits to the keep alive insertion state in which the keep alive packet is inserted. Thereafter, the counter is reset, and then the keep alive insertion state returns to the counter state. When a packet start is received from an upper layer, the counter state transits to the packet transfer state, and a packet is outputted to the subsequent stage. Thereafter, the counter is reset, and the packet transfer state returns to the count state.

FIG. 14 is a diagram illustrating an exemplary state machine when the keep alive is disabled. As illustrated in FIG. 14, when the keep alive is disabled, there are two states, excluding the keep alive insertion state, as compared with the keep-alive enabled state: an idle state provided in place of the count state, and the packet transfer state. The idle state is a state waiting for a packet start without counting time. When the keep alive is disabled, the idle state waiting for the packet start is in effect, and when the packet start is received from an upper layer, the idle state transits to the packet transfer state, and a packet is outputted to a subsequent stage. Thereafter, the state returns to the count state.

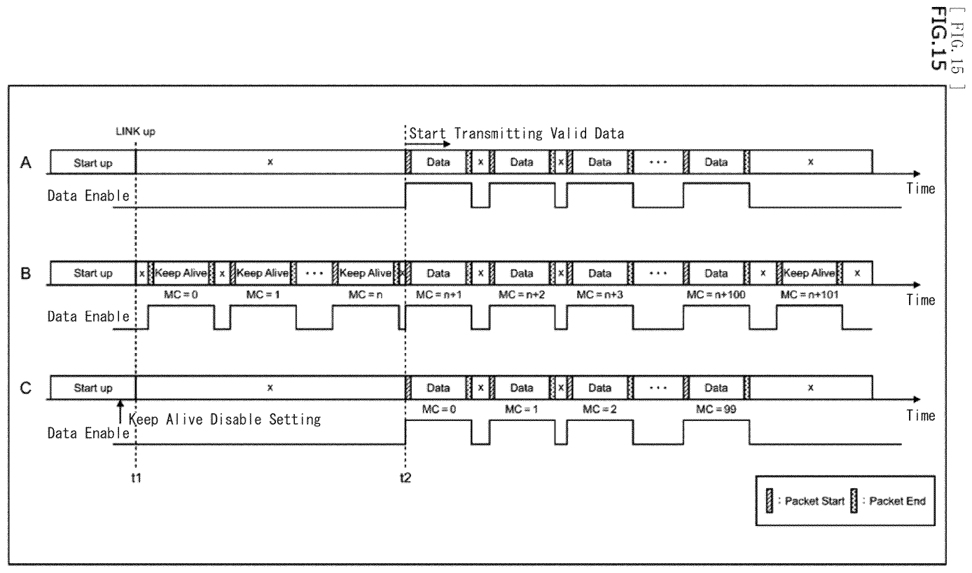

Here, a description will be given, with reference to a timing chart of FIG. 15, of a relation between input data and output data depending on the keep alive control signal (keep alive enable/disable signal) from the keep alive controller 121. Part A of FIG. 15 is a timing chart of the data to be inputted from the processing unit 101 to the keep alive controller 121. Part B of FIG. 15 is a timing chart of the data to be outputted from the keep alive controller 121 when the keep alive is enabled. Part C of FIG. 15 is a timing chart of the data to be outputted from the keep alive controller 121 when the keep alive is disabled. In each of the timing charts, the presence or absence of data is indicated by data enabling of an H level or an L level.

As illustrated in Part A of FIG. 15, no data is inputted to the keep alive controller 121 between time t1 and time t2 after the start-up. At the time t2, transmission of valid data starts, and a packet including the valid data is inputted. At this time, when the time period from the time t1 to the time t2 is longer than 5.5 μs, the keep alive controller 121 outputs the keep alive packet when the keep alive is enabled, as illustrated in Part B of FIG. 15. Also in the transmission of the keep alive packet, the MC number is added to the packet to be transmitted, and the value of the MC number is incremented for each keep alive packet.

In Part B of FIG. 15, the MC numbers 0 to n are added to the respective keep alive packets outputted between the time t1 and the time t2. Thus, the MC number to be added to the packets including valid data to be outputted after the time t2 starts with n+1, and the MC number is incremented for each packet. When the keep alive is enabled, it is difficult to identify or control the MC number of n. It is particularly difficult to check the MC number, set error information, and start outputting the valid data in order within 5.5 μs.

In contrast, as illustrated in Part C of FIG. 15, the keep alive controller 121 does not output the keep alive packet when the keep alive is disabled. Thus, the MC number to be added to the packets including valid data to be outputted after the time t2 starts with 0, and the MC number is incremented for each packet. Stopping the output of the keep alive packet in the period from the time t1 to the time t2 as described above facilitates identification and control of the MC number of the packet. The keep alive may be set disabled in the startup period before the time t1.

In this way, the generation (transmission) of the keep alive packet is switchable between the enabled state and the disabled state by the keep alive controller 121, and the generation (transmission) of the keep alive packet is controlled to be disabled in evaluating the retransmitting function. This allows the content of the packet to which an error has been inserted (noise insertion packet) to have reproducibility.

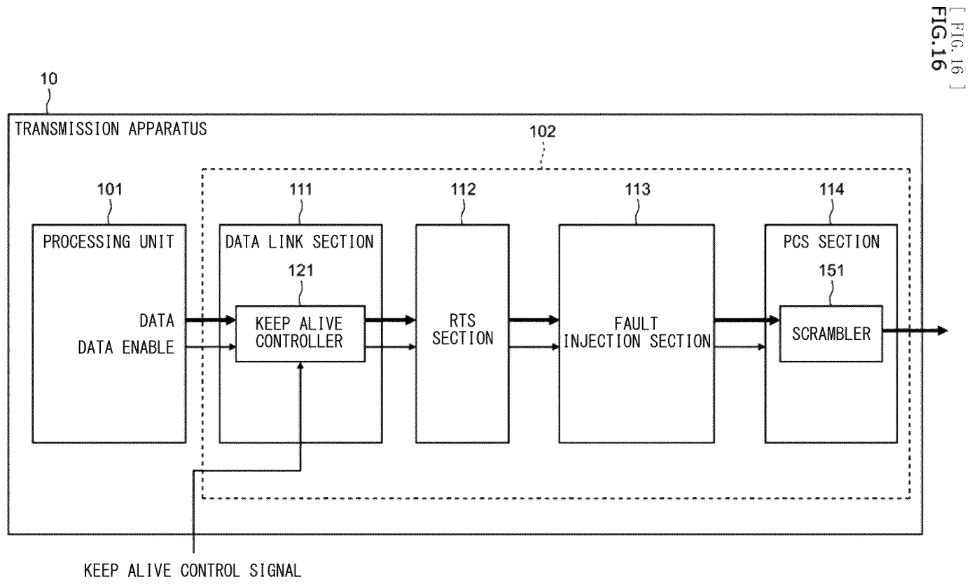

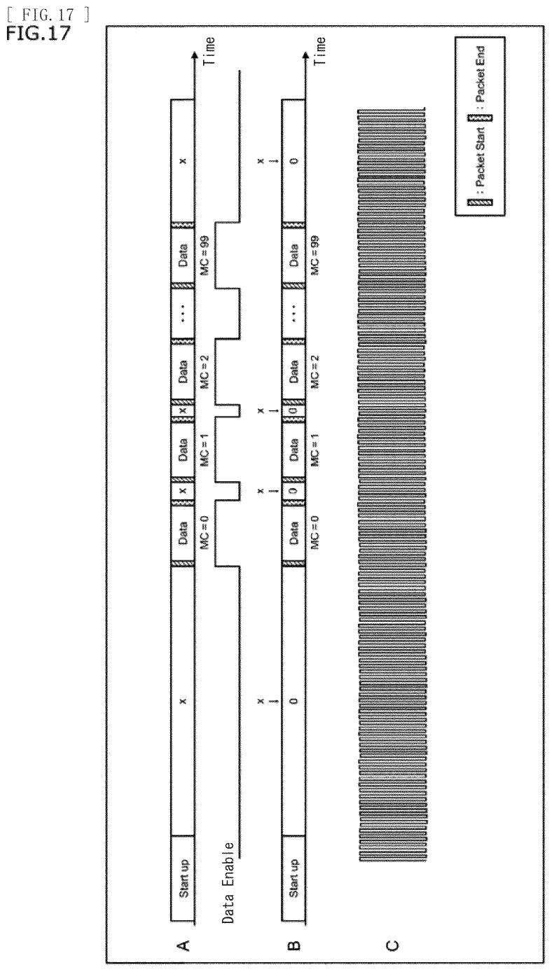

Since the keep alive controller 121 stops the keep alive packet, the PCS section 114 of the transmission apparatus 10 on the packet transmission side is provided with a scrambler 151, as illustrated in FIG. 16. Now, a description is given, with reference to a timing chart of FIG. 17, of a relation between the input data and the output data of the PCS section 114 when the keep alive is disabled. Part A of FIG. 17 is a timing chart of data to be inputted to the PCS section 114. Part B of FIG. 17 is a timing chart of data to be processed inside the PCS section 114. Part C of FIG. 17 is a timing chart of data to be outputted from the PCS section 114.

As illustrated in Part A of FIG. 17, the keep alive packet is stopped when the keep alive is disabled; therefore, no keep alive packet is inputted from immediately after the start-up to the start of transmission of valid data. At this time, as illustrated in Part B of FIG. 17, the PCS section 114 performs zero padding to a section where the data enable is the L level. Thereafter, as illustrated Part C of FIG. 17, the scrambler 151 in the PCS section 114 performs scrambling on the data having been subjected to the zero padding, resulting in an output of a random toggle signal.

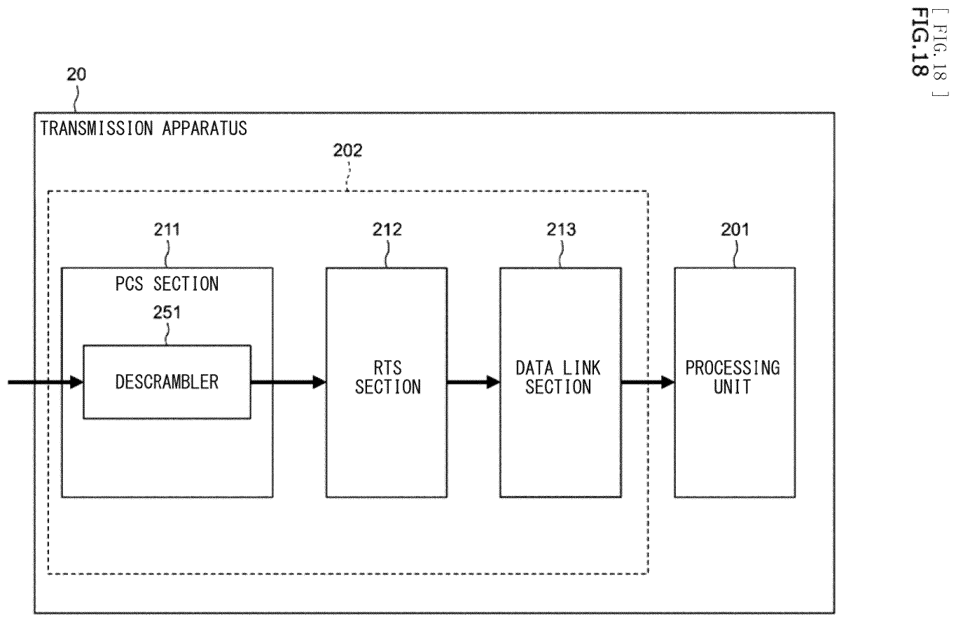

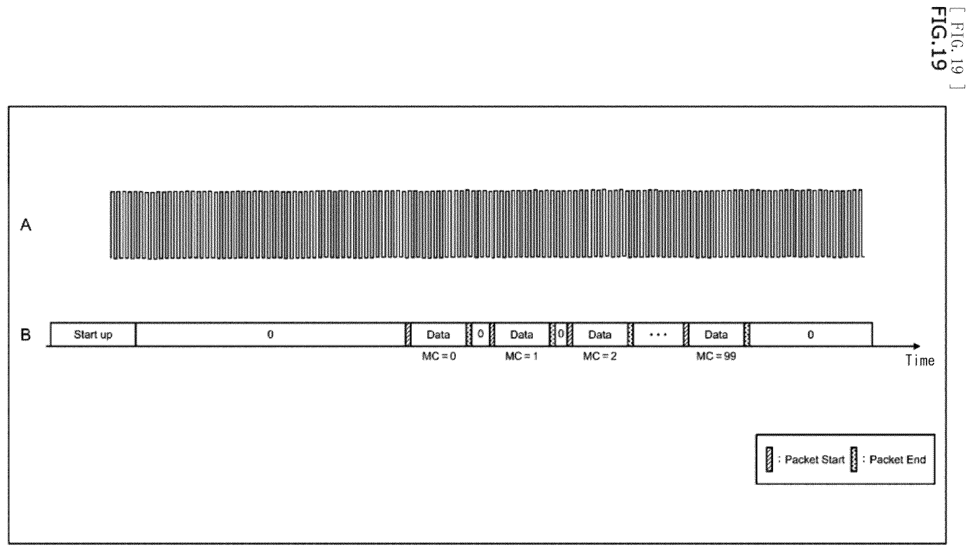

The transmission apparatus 20 that receives the packet transmitted from the transmission apparatus 10 illustrated in FIG. 16 may have a configuration illustrated in FIG. 18, for example. In FIG. 18, the transmission apparatus 20 includes the processing unit 201 and the transmission unit 202, and the transmission unit 202 includes a PCS section 211, an RTS section 212, and a data link section 213. The PCS section 211 is provided with a descrambler 251 that performs descrambling corresponding to scrambling by the scrambler 151. Now, a description is given, with reference to a timing chart of FIG. 19, of a relation between the input data and the output data of the PCS section 211 when the keep alive is disabled. Part A of FIG. 19 is a timing chart of the data to be inputted to the PCS section 211. Part B of FIG. 19 is a timing chart of the data to be outputted from the PCS section 211.

As illustrated in Part A of FIG. 19, the scrambler 151 of the PCS section 114 on the packet transmission side performs scrambling; therefore, a random toggle signal is inputted to the PCS section 211 on the packet reception side. At this time, as illustrated in Part B of FIG. 19. the descrambler 251 of the PCS section 211 performs descrambling on the inputted random toggle signal, to thereby restore original data. That is, the data having been subjected to the zero padding in the section where the data enable is the L level is restored. Accordingly, even when the keep alive packet is stopped in the transmission apparatus 10 on the packet transmission side, it is possible for the transmission apparatus 20 on the packet reception side to check whether the communication is established, by monitoring the 0 data between the PE (Packet End) and the PS (Packet Start).

### Effects Provided by Application of the Present Disclosure

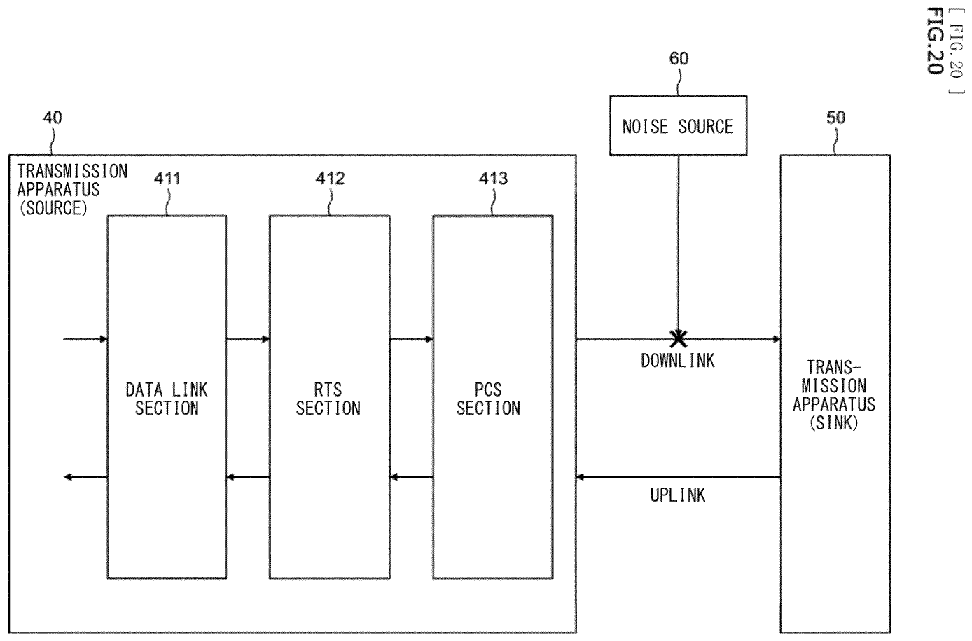

A description will be given of effects provided by applying the present disclosure. Here, a description will be given, with reference to FIGS. 20 to 22, of reproducible evaluation of the retransmitting function achievable by employing a scheme to which the present disclosure is applied, in comparison with a case where an existing scheme is employed.

FIG. 20 is a diagram illustrating a configuration in which the existing scheme is employed. In FIG. 20, the transmission and reception of the A-packet is performed between a transmission apparatus 40 which is a source and a transmission apparatus 50 which is a sink. The transmission apparatus 40 includes a data link section 411, an RTS section 412, and a PCS section 413. That is, the transmission apparatus 40 is not provided with the fault injection section 113 that inserts an error to the A-packet, as compared with the transmission apparatus 10 of FIG. 2.

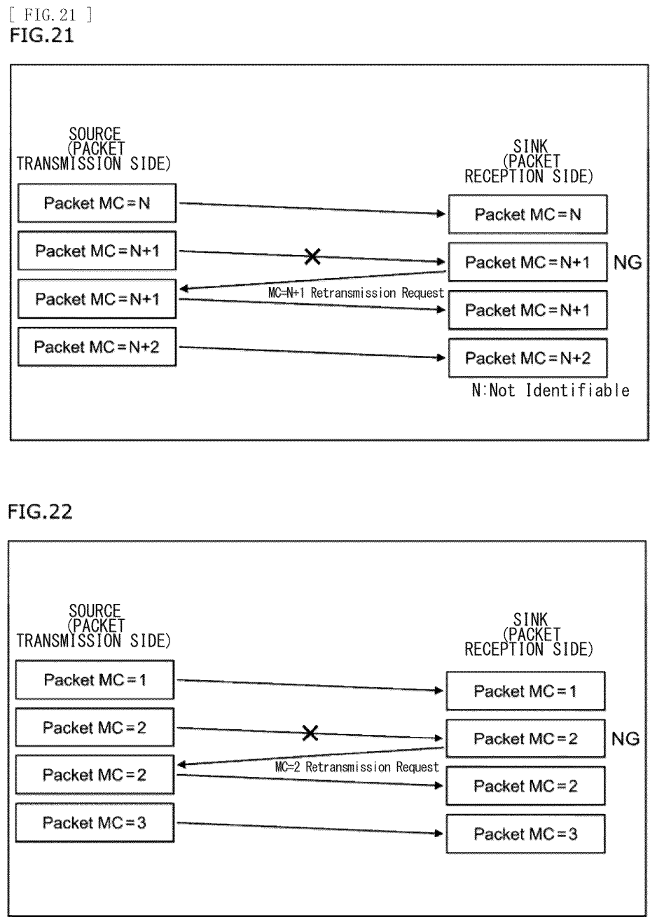

In FIG. 20, a noise source 60 is provided in a transmission path between the transmission apparatus 40 and the transmission apparatus 50, which causes an error in the A-packet. FIG. 21 is a diagram illustrating an example of a packet to be transmitted between the packet transmission side and the packet reception side when the existing scheme is employed. As illustrated in FIG. 21, it is assumed that, when the transmission apparatus 40 on the packet transmission side transmits a packet #N, a packet #N+1, a packet #N+2, and a packet #N+3 in order, an error occurs in the packet #N+1 due to a noise generated by the noise source 60.

In this case, since the error has occurred in the received packet #N+1, the transmission apparatus 50 on the packet reception side transmits a request for retransmitting the packet #N+1 to the transmission apparatus 40 on the packet transmission side; however, the transmission apparatus 50 is not capable of identifying the MC number of the A-packet to be requested for retransmitting. That is, in the case where the noise source 60 is provided to evaluate the packet retransmitting function, it is difficult to generate an error in a specific A-packet because the transmission apparatus 40 is not synchronized with the transmission apparatus 50. It is therefore difficult to achieve reproducible evaluation of the retransmitting function.

In contrast, according to the scheme to which the present disclosure is applied, the transmission apparatus 10 illustrated in FIG. 2 includes the fault injection section 113, and the fault injection section 113 is configured to insert an error to the A-packet. It is therefore unnecessary to provide the noise source 60 on the transmission path 30. The fault injection section 113 is configured to insert an error in a specific A-packet, based on a preset parameter, and determine any packet to be a target packet to which an error is to be inserted. For example, the fault injection section 113 is configured to intentionally insert an error, based on the designated MC number or at a designated frequency. It is therefore possible to achieve reproducible evaluation of the retransmitting function. Further, the transmission apparatus 10 of FIG. 2 includes the keep alive controller 121, and the keep alive controller 121 is configured to switch the keep alive to the disabled state. This allows the content of the A-packet to which an error is to be inserted to have reproducibility.

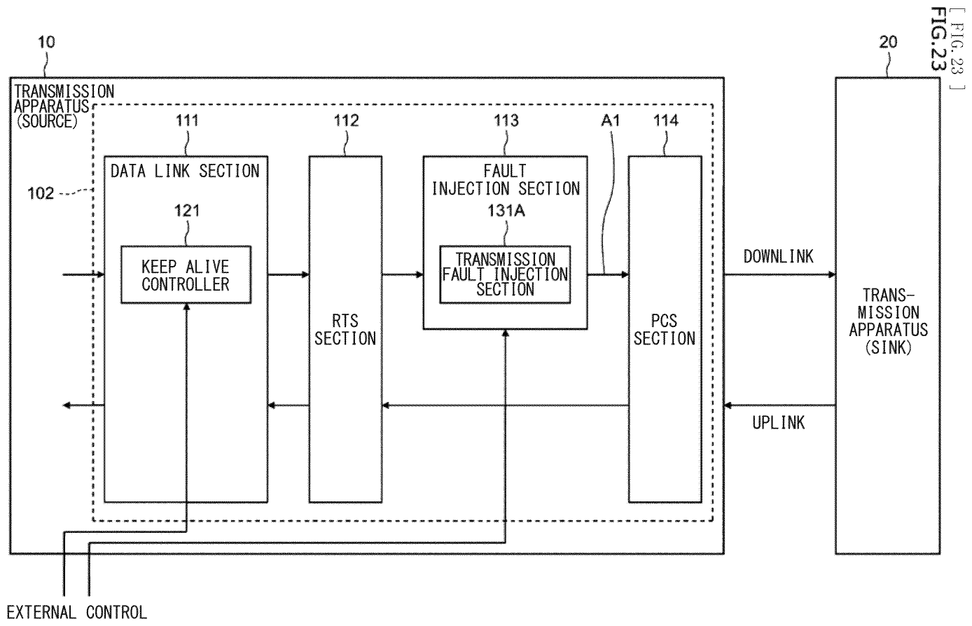

FIG. 22 is a diagram illustrating an example of a packet to be transmitted between the packet transmission side and the packet reception side when the scheme to which the present disclosure is applied is employed. As illustrated in FIG. 22, it is assumed that, when the transmission apparatus 10 on the packet transmission side transmits a packet #1, a packet #2, a packet #3, and a packet #4 in order, the transmission fault injection section 131A inserts an error in the packet #2, based on a preset parameter. In this case, since the error has occurred in the received packet #2, the transmission apparatus 20 on the packet reception side transmits a request for retransmitting the packet #2 to the transmission apparatus 10 on the transmission side. In this example, the transmission apparatus 20 is capable of identifying the MC number of the packet #2 in which the error has occurred, by setting the keep alive disabled. It is therefore possible to transmit the request for retransmitting the packet #2 to which the MC number of 2 is added.

Further, it is possible to achieve evaluation of the retransmitting function during the uplink even when the transmission apparatus 20 on the packet transmission side does not have the transmission fault injection function by employing the scheme to which the present disclosure is applied and by providing the reception fault injection section 131B in the transmission apparatus 10 on the packet reception side.

### Modification Example

In the above description, in the transmission unit 102 in the transmission apparatus 10, the fault injection section 113 includes the transmission fault injection section 131A and the reception fault injection section 131B; however, another configuration may be employed. FIG. 23 is a diagram illustrating another example of the configuration of the transmission unit 102 in the transmission apparatus 10 of FIG. 1. In FIG. 23, the fault injection section 113 includes only the transmission fault injection section 131A. In this case, the transmission unit 202 in the transmission apparatus 20 may include the transmission fault injection section 131A to insert an error in the A-packet transmitted during the downlink and uplink.

Although not illustrated, in the transmission unit 102 in the transmission apparatus 10, the fault injection section 113 may include only the reception fault injection section 131B. In this case, the transmission unit 202 in the transmission apparatus 20 may include the reception fault injection section 131B to insert an error in the A-packet transmitted during the downlink or uplink. Alternatively, although the transmission unit 102 in the transmission apparatus 10 which is a source includes the fault injection section 113 in the above description, the transmission unit 102 may include no fault injection section 113 and the transmission unit 202 in the transmission apparatus 20 which is a sink may include the fault injection section 113.

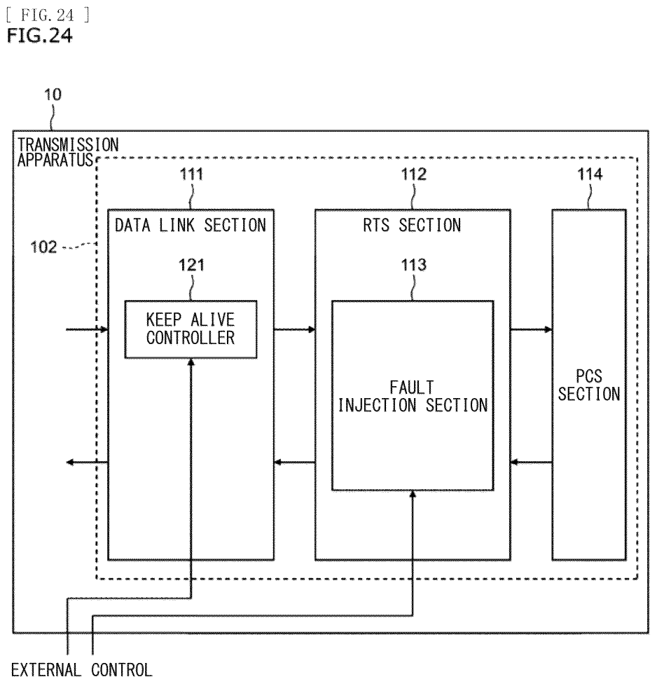

In the above description, in the transmission unit 102 in the transmission apparatus 10 of FIG. 2, the fault injection section 113 is disposed between the RTS section 112 and the PCS section 114; however, the fault injection section 113 may be disposed at a different position. For example, as illustrated in FIG. 24, the fault injection section 113 may be disposed inside the RTS section 112. In FIG. 24, during the packet transmission, the RTS section 112 performs the RTS processing on the packets supplied from the data link section 111, and thereafter causes the fault injection section 113 to insert an error in a specific transmission packet out of the transmission packets. Further, during the packet reception, the RTS section 112 causes the fault injection section 113 to insert an error in a specific reception packet out of the reception packets from the PCS section 114, and thereafter performs the RTS processing.

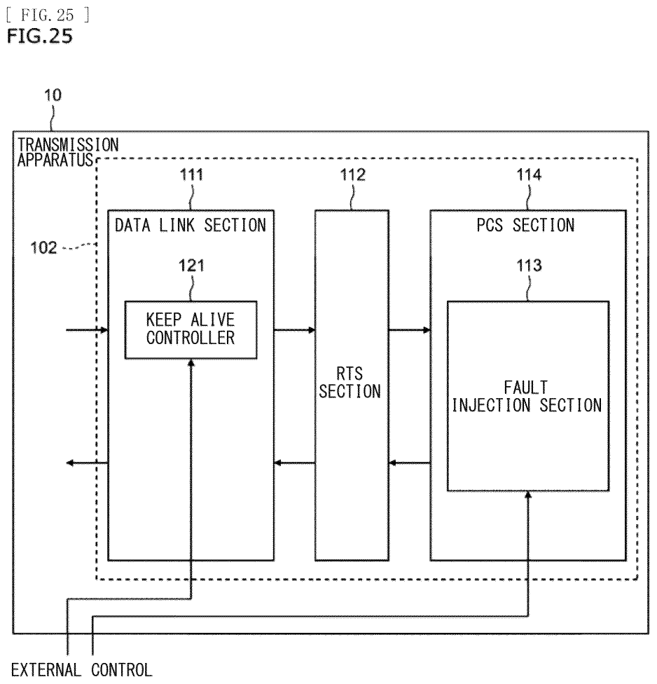

Further, as illustrated in FIG. 25, the fault injection section 113 may be disposed inside the PCS section 114. In FIG. 25, during the packet transmission, the PCS section 114 causes the fault injection section 113 to insert an error in a specific transmission packet out of the transmission packets from the RTS section 112, and thereafter performs the PCS processing. Further, during the packet reception, the PCS section 114 performs the PCS processing on the packets received, and thereafter causes the fault injection section 113 to insert an error in a specific transmission packet out of the transmission packets.

It should be noted that embodiments of the present disclosure are not limited to the embodiments described above, and various modifications may be made without departing from the gist of the present disclosure. Further, the effects described herein are only exemplified effects, and effects of the present disclosure may have effects other than the effects described herein.

It is to be noted that the present technology may also have the following configurations.
(1) A transmission apparatus including
   a transmission unit that transmits and receives packets to and from another transmission apparatus coupled via an A-PHY I/F defined in a MIPI standard, in which
   the transmission unit includes a first insertion section that inserts an error in a specific position of a specific transmission packet, out of transmission packets to be transmitted to the another transmission apparatus, based on a first parameter preset.
(2) The transmission apparatus according to (1), in which
   the transmission unit further includes a keep alive controller that performs control of transmitting a keep alive packet when a packet including valid data is not transmitted in a predetermined time period, and
   the keep alive controller stops transmitting the keep alive packet when the error is inserted in the specific transmission packet.
(3) The transmission apparatus according to (1), in which
   the first parameter includes an error insertion MC number that designates a MC number of the specific transmission packet, and
   the first insertion section inserts the error in the specific transmission packet to which the error insertion MC number designated by the first parameter is added.
(4) The transmission apparatus according to (3), in which
   the first parameter includes an error insertion maximum number that designates a maximum number of times of error insertion in the specific transmission packet, and
   the first insertion section inserts the error in the specific transmission packet, in accordance with the error insertion maximum number designated by the first parameter.
(5) The transmission apparatus according to (1), in which
   the first parameter includes an error insertion counter value that designates a frequency of error insertion in the specific transmission packet, and
   the first insertion section counts the transmission packets and inserts the error in the specific transmission packet when a count value becomes equal to the error insertion counter value designated by the first parameter.
(6) The transmission apparatus according to any one of (1) to (5), in which
   the first parameter includes an error kind that designates a kind of the error to be inserted in the specific transmission packet, and
   the first insertion section inserts the error in the specific position in accordance with the kind of the error designated by the first parameter when the error is inserted in the specific transmission packet.
(7) The transmission apparatus according to (6), in which
   the kind of the error includes CRC8 a calculation range of which is a header of the transmission packet, and CRC32 a calculation range of which is the header and a payload of the transmission packet, and
   the first insertion section
      changes a value of inspection data of the CRC8 to be added to the header of the specific transmission packet or changes a value of the header of the specific transmission packet when the kind of error designated by the first parameter is the CRC8, and
      changes a value of inspection data of the CRC32 to be added to a tail of the specific transmission packet or changes a value of the payload of the specific transmission packet when the kind of the error designated by the first parameter is the CRC32.
(8) The transmission apparatus according to any one of (1) to (5), in which the transmission unit further includes a second insertion section that inserts an error in a specific position of a specific reception packet, out of reception packets received from the another transmission apparatus, based on a second parameter preset.
(9) The transmission apparatus according to any one of (1) to (5), in which the transmission unit retransmits the specific transmission packet in response to a retransmission request from the another transmission apparatus.
(10) The transmission apparatus according to (2), in which
   the transmission unit further includes a RTS section that performs processing related to retransmission, and a PCS section that performs processing related to a physical coding sublayer, and
   the first insertion section is provided between the RTS section and the PCS section, inside the RTS section, or inside the PCS section.
(11) The transmission apparatus according to (10), in which
   the PCS section outputs a random toggle signal by performing zero padding to a section where data enable is an L level and thereafter performing scrambling on an input from the first insertion section with a scrambler, and
   the PC'S section of the another transmission apparatus includes a descrambler corresponding to the scrambler.
(12) a Transmission Method Including:
   transmitting and receiving packets, with a transmission apparatus, to and from another transmission apparatus coupled via an A-PHY I/F defined in a MIPI standard, and
   inserting an error in a specific position of a specific transmission packet, out of transmission packets to be transmitted to the another transmission apparatus, based on a first parameter preset.

### REFERENCE SIGNS LIST

1: transmission system, 10: transmission apparatus, 20: transmission apparatus, 101: processing unit, 102: transmission unit, 111: data link section, 112: RTS section, 113: fault injection section, 114: PCS section, 121: keep alive controller, 131A: transmission fault injection section, 131B: reception fault injection section, 132: fault injection module, 141: MC checker, 142: packet counter, 143: selector, 144: selector, 145: error insertion execution unit, 151: scrambler, 201: processing unit, 202: transmission unit, 211: PCS section, 212: RTS section, 213: data link section

1. A transmission apparatus comprising
a transmission unit that transmits and receives packets to and from another transmission apparatus coupled via an A-PHY I/F defined in a MIPI standard, wherein
the transmission unit includes a first insertion section that inserts an error in a specific position of a specific transmission packet, out of transmission packets to be transmitted to the another transmission apparatus, based on a first parameter preset.

2. The transmission apparatus according to claim 1, wherein
the transmission unit further includes a keep alive controller that performs control of transmitting a keep alive packet when a packet including valid data is not transmitted in a predetermined time period, and
the keep alive controller stops transmitting the keep alive packet when the error is inserted in the specific transmission packet.

3. The transmission apparatus according to claim 1, wherein
the first parameter includes an error insertion MC number that designates a MC number of the specific transmission packet, and
the first insertion section inserts the error in the specific transmission packet to which the error insertion MC number designated by the first parameter is added.

4. The transmission apparatus according to claim 3, wherein
the first parameter includes an error insertion maximum number that designates a maximum number of times of error insertion in the specific transmission packet, and
the first insertion section inserts the error in the specific transmission packet, in accordance with the error insertion maximum number designated by the first parameter.

5. The transmission apparatus according to claim 1, wherein
the first parameter includes an error insertion counter value that designates a frequency of error insertion in the specific transmission packet, and
the first insertion section counts the transmission packets and inserts the error in the specific transmission packet when a count value becomes equal to the error insertion counter value designated by the first parameter.

6. The transmission apparatus according to claim 1, wherein
the first parameter includes an error kind that designates a kind of the error to be inserted in the specific transmission packet, and the first insertion section inserts the error in the specific position in accordance with the kind of the error designated by the first parameter when the error is inserted in the specific transmission packet.

7. The transmission apparatus according to claim 6, wherein
the kind of the error includes CRC8 a calculation range of which is a header of the transmission packet, and CRC32 a calculation range of which is the header and a payload of the transmission packet, and
the first insertion section
changes a value of inspection data of the CRC8 to be added to the header of the specific transmission packet or changes a value of the header of the specific transmission packet when the kind of error designated by the first parameter is the CRC8, and
changes a value of inspection data of the CRC32 to be added to a tail of the specific transmission packet or changes a value of the payload of the specific transmission packet when the kind of the error designated by the first parameter is the CRC32.

8. The transmission apparatus according to claim 1, wherein the transmission unit further includes a second insertion section that inserts an error in a specific position of a specific reception packet, out of reception packets received from the another transmission apparatus, based on a second parameter preset.

9. The transmission apparatus according to claim 1, wherein the transmission unit retransmits the specific transmission packet in response to a retransmission request from the another transmission apparatus.

10. The transmission apparatus according to claim 2, wherein
the transmission unit further includes a RTS section that performs processing related to retransmission, and a PCS section that performs processing related to a physical coding sublayer, and
the first insertion section is provided between the RTS section and the PCS section, inside the RTS section, or inside the PCS section.

11. The transmission apparatus according to claim 10, wherein
the PCS section outputs a random toggle signal by performing zero padding to a section where data enable is an L level and thereafter performing scrambling on an input from the first insertion section with a scrambler, and
the PCS section of the another transmission apparatus includes a descrambler corresponding to the scrambler.

12. A transmission method comprising:
transmitting and receiving packets, with a transmission apparatus, to and from another transmission apparatus coupled via an A-PHY I/F defined in a MIPI standard, and
inserting an error in a specific position of a specific transmission packet, out of transmission packets to be transmitted to the another transmission apparatus, based on a first parameter preset.
